(19) United States
(12) Patent Application Publication
(10) Pub. No.: US 2024/0394739 A1
(43) Pub. Date: Nov. 28, 2024

(54) RECEIVING AND ANALYZING CONSUMER BEHAVIOR DATA USING VISIBLE LIGHT COMMUNICATION

(71) Applicant: SIGNIFY HOLDING B.V., EINDHOVEN (NL)

(72) Inventors: JIN YU, LEXINGTON, MA (US); YIZHOU ZANG, MALDEN, MA (US); ABHISHEK MURTHY, ARLINGTON, MA (US); PETER DEIXLER, ARLINGTON, MA (US)

(21) Appl. No.: 18/689,125

(22) PCT Filed: Aug. 31, 2022
(86) PCT No.: PCT/EP2022/074202

§ 371 Date: Mar. 5, 2024

Related U.S. Application Data
(60) Provisional application No. 63/241,254, filed on Sep. 7, 2021.

(30) Foreign Application Priority Data
Sep. 27, 2021 (EP) 21199069.2

(51) Int. Cl. G06Q 30/0204

(52) U.S. Cl. CPC G06Q 30/0205

(57) ABSTRACT

A method for analyzing consumer behavior within a retail space can include receiving data associated with consumers in communications signals from local devices located in the retail space, where the local devices receive some of the data in visible light communication (VLC) signals broadcast by electrical devices, where each local device is associated with one of the consumers in the retail space at a point in time, and where the data lacks information that identifies the consumers. The method can also include attributing, by the controller using a multi-stage clustering process, the data to discrete consumers for a period of time that includes each point in time. The method can further include assigning the discrete consumers to at least one of a number of groups defined by one or more characteristics measured from the data, where the discrete consumers within a group share a common characteristic.

### TECHNICAL FIELD

The present disclosure relates generally to visible light communication (VLC), and more particularly to systems, methods, and devices for using VLC networks to receive and analyze consumer behavior data.

### BACKGROUND

Traditional brick-and-mortar retail stores face increasingly competitive environments, partly because of online competition and partly because of concerns some consumers have about entering into public places. The more data that retailers can collect, analyze, and use about the behavior of consumers while in their store, the better equipped the retailers can be to improve their consumers' experience.

However, consumer privacy issues are of great concern. Specifically, consumers are increasingly wary about how their personal information is being used without their knowledge or permission. Therefore, obtaining information about consumer behavior should be done carefully and without invoking privacy concerns. Also, in order to save costs, the use of existing infrastructure within a retail space to obtain information about consumer behavior is preferred to investing in new equipment dedicated to that purpose.

### SUMMARY

In general, in one aspect, the disclosure relates to a method for analyzing consumer behavior within a retail space. The method can include receiving, by a controller, a plurality of data associated with a plurality of consumers in a plurality of communications signals from a plurality of local devices located in the retail space, where the plurality of local devices receives some of the plurality of data in VLC signals broadcast by a plurality of electrical devices, where each local device is associated with a location of one of the plurality of consumers in the retail space at a point in time, and where the plurality of data lacks information that identifies the plurality of consumers. The method can also include attributing, by the controller using a multi-stage clustering process, the plurality of data to discrete consumers among the plurality of consumers over a period of time that includes each point in time. The method can further include assigning the discrete consumers to at least one of a plurality of groups defined by one or more characteristics measured from the plurality of data, where the discrete consumers within a group of the plurality of groups share a common characteristic.

In another aspect, the disclosure relates to a system for analyzing consumer behavior within a retail space. The system can include a plurality of electrical devices that broadcast a plurality of VLC signals in a retail space over a period of time, where each of the plurality of VLC signals comprises an identification of an electrical device sending the VLC signal. The system can also include a plurality of local devices that receive the plurality of VLC signals broadcast by the plurality of electrical devices, where each local device is used a consumer among a plurality of consumers at a point in time within the period of time. The system can further include a network manager communicably coupled to the plurality of local devices, where the network manager receives a plurality of communication signals from the plurality of local devices, where each communication signal comprises the identification of the electrical device sending the VLC signal and an image or metadata associated with the image, taken by the local device, of the electrical device. The network manager can attribute, using a multi-stage clustering process, data in each of the plurality of communication signals to discrete consumers among the plurality of consumers for the period of time. The network manager can also assign the discrete consumers to at least one of a plurality of groups defined by one or more characteristics measured from the data in the plurality of communication signals, wherein the discrete consumers within a group of the plurality of groups share a common characteristic

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a block diagram of a system according to certain example embodiments.

FIG. 2 shows a block diagram of a VLC device of an electrical device of FIG. 1.

FIG. 3 shows a block diagram of part of a local device of FIG. 1.

FIG. 4 shows a block diagram of the network manager of FIG. 1.

FIG. 5 shows a computing device in accordance with certain example embodiments.

FIG. 6 shows a flowchart of a method for analyzing consumer behavior within a retail space according to certain example embodiments.

FIG. 7 shows a plot of locational data points for a local device within a retail space according to certain example embodiments.

FIG. 8 shows a graph of clusters of data points for a local device within a retail space according to certain example embodiments.

FIGS. 9A through 9C show plots of three different user groups categorized according to certain example embodiments.

### DETAILED DESCRIPTION

In general, example embodiments provide systems, methods, and devices for receiving and analyzing consumer behavior data using VLC. Example embodiments can provide a number of benefits. Such benefits can include, but are not limited to, more accurate collection, interpretation, and use of consumer behavior data, use of existing lighting systems and/or other systems (e.g., security systems, fire protection systems), user control, protection of consumer privacy, and providing a more optimal retail experience. Example embodiments can be used with new electrical devices that have VLC capabilities or with existing electrical devices that are retrofit with VLC capabilities.

One type of electrical device with VLC capabilities can be a luminaire. Luminaires can include or be part of light fixtures, lighting devices, and/or lighting systems. A luminaire has a principal purpose of providing general illumination to a volume of space. A luminaire with VLC capabilities can be any type of luminaire, including but not limited to recessed light fixtures (e.g., down can light fixtures), pendent lights, table lamps, troffers, emergency light fixtures, illuminated exit signs, parking lot light fixtures, street lights, sidewalk light fixtures, and ceiling fan lights. Luminaires can use any type of lighting technology, including but not limited to light-emitting diodes (LEDs), incandescent, halogen, fluorescent, and sodium vapor.

Luminaires with VLC capabilities can be located in one or more of any of a number of retail environments. Examples of such retail environments can include, but are not limited to, indoors, outdoors, a flea market, a movie theater concession area, a retail store (e.g., a grocery store, a sporting goods store, a furniture store, an electronics store, an appliance store, a hardware store, a home goods store, a souvenir store, a clothing store, a convenience store), and a farmer's market, any of which can be climate-controlled or non-climate-controlled. Electrical devices (e.g., luminaires) with VLC capabilities can be integrated with or into any of a number of different structures. Such structures can include, but are not limited to, a ceiling, a floor, a pole, an I-beam, drywall, wood studs, a tree, a wall, and a building facade.

Electrical devices (including components thereof) with VLC capabilities can be made of one or more of a number of suitable materials to allow the electrical device to meet certain standards and/or regulations while also maintaining operational proficiency. Examples of such materials can include, but are not limited to, aluminum, stainless steel, fiberglass, glass, plastic, polymer, ceramic, and rubber. The National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) are examples of entities that set standards and/or regulations with which an electrical device with VLC capabilities complies. Use of example embodiments described herein meet (and/or allow an electrical device with VLC capabilities to meet) such standards and/or regulations when applicable.

Similarly, various governmental agencies (e.g., national government agencies, state agencies, provincial agencies, city agencies, municipal agencies, cooperative agencies) can set laws, standards, and/or regulations with respect to consumer privacy and/or data privacy. Example embodiments described herein are designed to meet such laws, standards, and/or regulations, as applicable.

In the foregoing figures showing example embodiments of receiving and analyzing consumer behavior data using VLC, one or more of the components shown may be omitted, repeated, and/or substituted. Accordingly, example embodiments of receiving and analyzing consumer behavior data using VLC should not be considered limited to the specific arrangements of components shown in any of the figures. For example, features shown in one or more figures or described with respect to one embodiment can be applied to another embodiment associated with a different figure or description.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of receiving and analyzing consumer behavior data using VLC will be described more fully hereinafter with reference to the accompanying drawings, in which example embodiments of receiving and analyzing consumer behavior data using VLC are shown. Receiving and analyzing consumer behavior data using VLC may, however, be embodied in many different forms and should not be construed as limited to the example embodiments set forth herein. Rather, these example embodiments are provided so that this disclosure will be thorough and complete, and will fully convey the scope of receiving and analyzing consumer behavior data using VLC to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of receiving and analyzing consumer behavior data using VLC. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

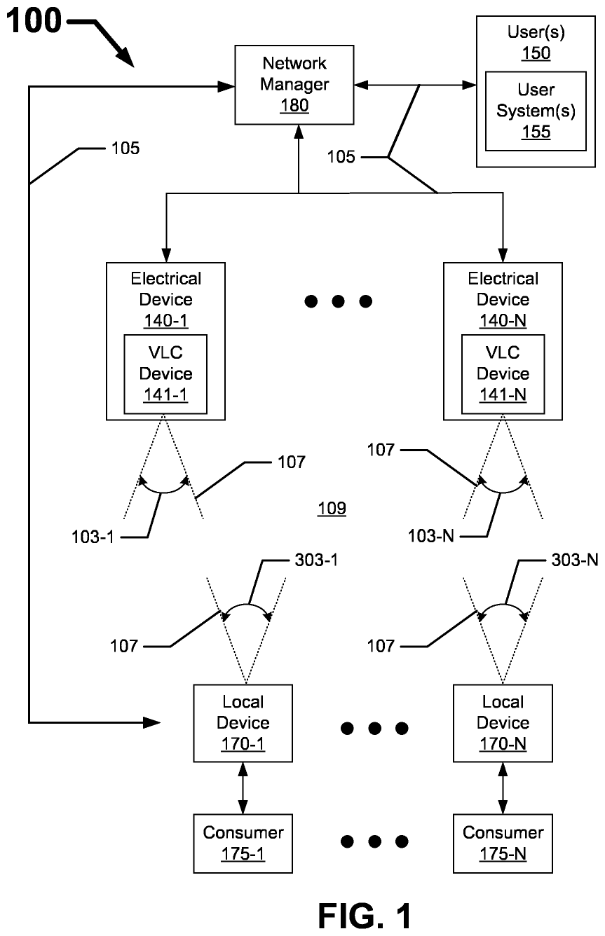

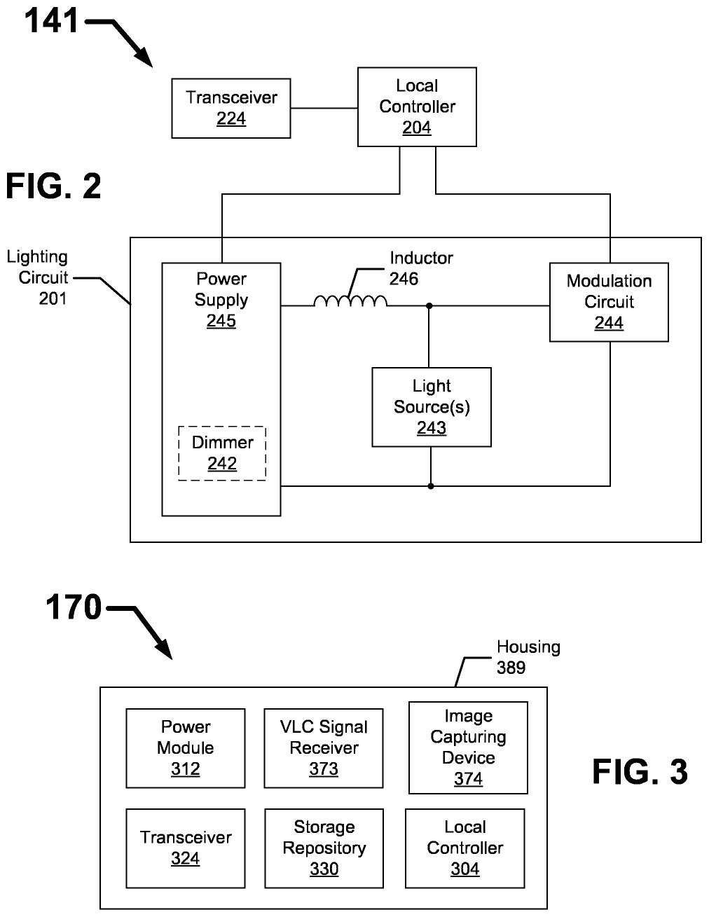

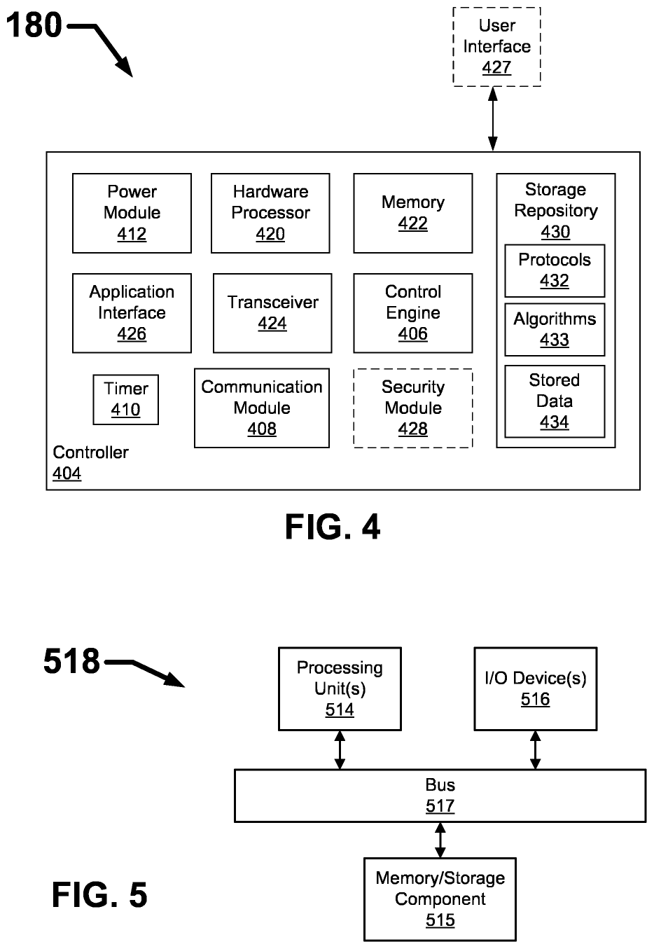

FIG. 1 shows a block diagram of a system 100 according to certain example embodiments. FIG. 2 shows a block diagram of a VLC device 141 of an electrical device 140 of FIG. 1. FIG. 3 shows a block diagram of a local device 170 of FIG. 1. FIG. 4 shows a block diagram of the network manager 180 of FIG. 1. Referring to FIGS. 1 through 4, the system 100 includes the network manager 180, one or more users 150 (which can include one or more user systems 155), multiple electrical devices 140 (e.g., electrical device 140-1, electrical device 140-N), multiple local devices 170 (e.g., local device 170-1, local device 170-N), and multiple consumers 175 (e.g., consumer 175-1, consumer 175-N).

At least the electrical devices 140 (including the associated VLC devices 141), the consumers 175, and the local devices 170 are located in a retail space 109. The components shown in FIGS. 1 through 4 are not exhaustive, and in some embodiments, one or more of the components shown in FIGS. 1 through 4 may not be included in a component of the system 100. Any component of the system 100 can be discrete or combined with one or more other components of the system 100.

A consumer 175 can be a person that is present in a retail space 109. A consumer 175 can be in the retail space 109 to perform one or more of a number of functions, including but not limited to buying products and/or services, conducting research on products and/or services, and returning a product and/or service. A consumer 175 can be a direct consumer, a buying agent (e.g., fulfilling online orders for curbside pick-up), or anyone else who performs one or more of the functions listed above.

Each consumer 175 has a local device 170 associated with that consumer 175. For example, in this case, consumer 175-1 is associated with local device 170-1, and consumer 175-N is associated with local device 170-N. A local device 170 can have any of a number of forms, including but not limited to an application on a smart device (e.g., a cell phone, a smart watch) owned by the consumer 175, a dedicated device (e.g., a device integrated with a shopping cart or carrying basket) used by the retailer utilizing the retail space 109, and a badge worn by the consumer 175. In some cases, a local device 170 is unassociated with a consumer 175, but rather is associated with some other movable device within the retail space 109. For example, a local device 170 can be located on a forklift operated within the retail space 109 by an employee.

Each local device 170 is configured to receive, and in some cases also send, VLC signals 107 within a VLC range 303 that are broadcast by a VLC device 141 of one or more electrical devices 140. In embodiments, the local device 170 can include or correspond to a mobile local device 170, mobile throughout the retail space 109, following the movement of an associated consumer 175 at various points in time throughout a period of time (e.g., a business day). A local device 170 can include one or more of a number of components. For example, as shown in FIG. 3, a local device 170 can include a housing 389 that has disposed therein or thereon a power module 312, a VLC signal receiver 373, a transceiver 324, a storage repository 330, an image capturing device 374, and a local controller 304. In certain example embodiments, a local device 170 can both send and receive VLC signals 107, in which case the local device 170 can also include a VLC generator (not shown in FIG. 3). In certain example embodiments, each local device 170 can also send communication signals that use non-VLC technology. Examples of non-VLC technologies can include, but are not limited to, radio frequency signals (e.g., using Bluetooth). A local device 170 can be disposed within, on, or remotely from the associated consumer 175.

The power module 312 of a local device 170 can provide power to one or more other components (e.g., VLC signal receiver 373, local controller 304) of the local device 170. The power module 312 can be substantially similar to (or at least include some of the capabilities of) the power module 412 of the controller 404 of the network manager 180, as described below. The transceiver 324 of the local device 170 can receive (and in some cases also send) VLC signals 107. Specifically, the transceiver 324 can be used to transfer data, using VLC signals 107, between the local device 170 and the VLC device 141 of one or more electrical devices 140. The transceiver 324 can also send and receive communication signals that are non-VLC signals with the network manager 180 using one or more of the communication links 105. The transceiver 324 can be substantially similar to (or at least include some of the capabilities of) the transceiver 424 of the controller 404 of the network manager 180, as described below.

The transceiver 324 can use one or more of any number of suitable communication protocols when sending and/or receiving signals. Such communication protocols can be stored in the storage repository 330. Further, any transceiver information for the VLC device 141 of one or more electrical devices 140 and for the network manager 180 can be part of the data stored in the storage repository 330. The storage repository 330 of the local device 170 can be substantially similar to (or at least include some of the capabilities of) the storage repository 430 of the controller 404 of the network manager 180, as described below.

The transceiver 324 can use one or more of a number of technologies to detect a VLC signal 107 broadcast by one or more VLC devices 141 at a point in time. For example, the transceiver 324 can use optical technology to detect a VLC signal 107 within a specific range of acceptance angles. As another example, the transceiver 324 can include an angular correction filter so that it can detect a VLC signal 107, regardless of the angle at which the VLC signal 107 reaches the transceiver 324. As yet another example, the transceiver 324 can include an ambient light filter so that the transceiver 324 detects the VLC signal 107 (e.g., modulated light pattern) from among one or more other sources of light. As still another example, the transceiver 324 can include another filter that only allows the transceiver 324 to detect certain characteristics of light (e.g., a range of wavelengths) that are part of the VLC signal 107.

The transceiver 324 can search for a light output (and, thus, a VLC signal 107) on a regular basis (e.g., constantly, every 30 seconds), based on the occurrence of some event (e.g., an instruction received by the local controller 304 from the network manager 180), and/or based on some other factor. For example, a transceiver 324 can activate whenever it senses light, and it can also identify and decode a VLC signal 107 embedded in the light.

The image capturing device 374 of a local device 170 is configured to capture one or more images (e.g., a still image, a video clip) as instructed by the local controller 304. An image captured by the image capturing device 374 of a local device 170 can include metadata associated with the image. Such metadata can identify the location of any electrical devices 140 and/or VLC devices 141 captured in the image. In some cases, the image capturing device 374 is in a fixed position relative to the housing 389 of the local device 170. Alternatively, one or more aspects (e.g., pan, tilt) of the image capturing device 374 can be adjustable relative to the housing 389 of the local device 170. The image capturing device 374 can include other adjustable features, including but not limited to zoom capability, flash control, and modes (e.g., landscape, close-up). When a VLC signal 107 is received by the local device 170, the image capturing device 374 can be directed toward the VLC device 141 that broadcast the VLC signal 107 based on characteristics (e.g., angle of arrival) of the VLC signal 107.

The control of these different optical and physical adjustable features of the image capturing device 374 can be controlled by the local controller 304 or manually by the associated consumer 175. In certain example embodiments, the image capturing device 374 captures one or more images of a VLC device 141 (and so also the associated electrical device 140) that sent a VLC signal 107 that was just received by the VLC signal receiver 373, where the VLC signal 107 includes an identification of the VLC device 141 and/or the associated electrical device 140.

The VLC signal receiver 373 of a local device 170 can be used to receive VLC signals 107 that are broadcast from one or more VLC devices 141 that are within the VLC range 303 for that local device 170 (e.g., VLC range 303-1 for local device 170-1, VLC range 303-N for VLC local device 170-N). In some cases, the VLC signal receiver 373 can also determine the content (e.g., identification information of the sending VLC device 141 and/or associated electrical device 140) and/or characteristics (e.g., angle of arrival) of a VLC signal 107.

The local controller 304 of the local device 170 can coordinate and control the other components (e.g., the power module 312, the VLC signal receiver 373, the image capturing device 374) of the local device 170. For example, the local controller 304 can instruct the VLC signal receiver 373 to receive a VLC signal 107 received from a VLC device 141 of an electrical device 140 and extract an identification of the VLC device 141 and/or the electrical device 140. As another example, the local controller 304 can instruct the image capturing device 374 to capture an image that includes the VLC device 141 (and so also the corresponding electrical device 140) that broadcast a VLC signal 107 that was just received by the VLC receiver 373.

As yet another example, the local controller 304 can adjust one or more settings (e.g., optical settings, physical adjustment settings) of the image capturing device 374 and otherwise operate the image capturing device 374. This control of the settings of the image capturing device 374 can be based on the characteristics (e.g., angle of arrival) of the VLC signal 107. In certain example embodiments, the local controller 304 can be configured to extract data from each VLC signal 107 broadcast by a VLC device 141 and put such data in a format that can be sent to and understood by the controller 404 of the network manager 180. In certain example embodiments, the communication signals sent to the network manager 180 do not include identification information of the local device 170 or the associated consumer 175.

As still another example, the local controller 304 can manage the power generated by the power module 312 and distributed to any or all of the other components of the local device 170. The local controller 304 of the local device 170 can be substantially similar to (or at least include some of the capabilities of) the controller 404 of the network manager 180, as described below. The local controller 304 of the local device 170 can correspond to a computer system as described below with regard to FIG. 5.

Each electrical device 140 can include a VLC device 141. For example, in this case, the electrical device 140-1 includes the VLC device 141-1, and the electrical device 140-N includes the VLC device 141-N. Each electrical device 140 is a device that operates, at least in part, using electricity. Examples of an electrical device 140 can include, but are not limited to, a luminaire, a sensor device, a security camera, a digital sign, a smoke detector, a kiosk, and a control panel. Each of the electrical devices 140 are disposed, at least in part, in the retail space 109.

The VLC device 141 of an electrical device 140 is configured to send VLC signals 107 to, and in some cases also receive VLC signals 107 from, one or more local devices 170 that are within the VLC range 103 of that VLC device 141 (e.g., VLC range 103-1 for VLC device 141-1, VLC range 103-N for VLC device 141-N) when a VLC signal 107 is broadcast. A VLC device 141 can include one or more components. For example, as shown in FIG. 2, a VLC device 141 can include a lighting circuit 201, a transceiver 224, and a local controller 204. The lighting circuit 201 of FIG. 2 includes a power supply 245, a modulation circuit 244, one or more light sources 243, and an inductor 246. The power supply 245 can optionally include a dimmer 242.

The power supply 245 and the modulation circuit 244 in this case are both connected in parallel with the light sources 243 to form the lighting circuit 201. One or more of a number of other components (e.g., the inductor 246, a capacitor, a resistor, a switch, an integrated circuit) can be used in the lighting circuit 201 between the power supply 245, the modulation circuit 244, and/or the light sources 243. The transceiver 224 is configured to broadcast a VLC signal 107, received by one or more local devices 170, into the retail space 109. In some cases, receive a VLC signal 107 emitted by one or more local devices 170. The VLC signal 107 broadcast by the local controller 204 includes an identification of the VLC device 141 and/or the associated electrical device 140.

In some cases, for a VLC signal 107 received by the transceiver 224, the content of the VLC signal 107 is interpreted by the local controller 204. The transceiver 224 of the VLC device 141 can be a stand-alone component that is physically separate from the remaining components of the VLC device 141, but within the VLC range 103 of the light emitted from the light source of another VLC device 141 that is part of an adjacent electrical device 140. In certain example embodiments, the transceiver 224 and the modulation circuit 244 are communicably coupled to the local controller 204 so that the modulation circuit 244 generates a VLC signal 107 based on a VLC signal 107 received by the transceiver 224. As such, the VLC device 141 can act as a relay in a series of VLC devices 141 in a VLC network.

The one or more light sources 243 can be part of a luminaire (to provide general illumination) or can be dedicated to sending VLC signals 107. The various components of the VLC device 141 can be positioned within the same housing and/or in separate locations. The power supply 245 can be a device or series of components that supply power to the light sources 243. Specifically, the power supply 245 receives power from a source (e.g., AC mains), processes the power, and delivers the processed power to the light sources 243. The power supply 245 can also receive, process, and/or deliver control signals to the light source 243. The control signals and/or processed power can be received by the light source 243 from the power supply 245 using wired and/or wireless technology. Similarly, the signals (e.g., power, control) received by the power supply 245 from external sources can be received using wired and/or wireless technology.

The optional dimmer 242 of the power supply 245, if included, as when the associated electrical device 140 is a luminaire, can control the amount of power (adjusts the power signal) delivered by the power supply 245 to the light source 243. The dimmer 242 can be controlled remotely by a user 150 and/or by some other source. By controlling the power signal delivered by the power supply 245 to the light source 243, the dimmer 242 controls the amount of light output by the light source 243. In some cases, the dimmer 242 can be a separate device from the power supply 245.

The modulation circuit 244 controls the VLC signal component (the VLC signal 107) of the light emitted by the light sources 243. For example, when the corresponding electrical device 140 is a luminaire, the modulation circuit 244 sends, in parallel with the power signal sent by the power supply 245, a varying amount of power (for the VLC signal 107) to the light source 243. The VLC signal 107 generated by the modulation circuit 244 can be set at a different frequency (e.g., greater than one GHz, greater than one kHz) relative to the frequency (e.g., 120 Hz) of the power signal generated by the power supply 245.

The power signal sent by the power supply 245 to the light sources 243 is added to the VLC signal 107 sent by the modulation circuit 244 to the light source 243, and the light source 243 emits light based on the sum of the power signal received from the power supply 245 and the VLC signal 107 received from the modulation circuit 244. In such a case, the light emitted by the light sources 243 can include one or more VLC signals 107. In some cases, the modulation circuit 244 can be part of the power supply 245. As an example, output current of a power supply 245 (e.g., an LED driver) is modulated in the kHz/MHz or GHz range, and data is digitized into that modulated signal by the modulation circuit 244. Additional data could also be embedded in the modulated current signal by varying its modulated frequency.

The local controller 204 of a VLC device 141 can be configured to control and communicate with the transceiver 224, the power supply 245, and the modulation circuit 244. The local controller 204 of a VLC device 141 can also be configured to communicate with the network manager 180 using one or more communication links 105. The local controller 204 of a VLC device 141 can be substantially similar to (or at least include some of the capabilities of) the controller 404 of the network manager 180, as described below. The local controller 204 of a VLC device 141 can correspond to a computer system as described below with regard to FIG. 5.

In some cases, when the VLC range 103 (e.g., VLC range 103-1) of one VLC device 141 (e.g., VLC device 141-1) overlaps with the VLC range 103 (e.g., VLC range 103-N) of another VLC device 141 (e.g., VLC device 141-N), those two VLC devices 141 can send and receive VLC signals 107 between each other. Such communication using VLC signals 107 between VLC devices 141 can be utilized when, for example, an electrical device 140 has temporarily or permanently lost its capability to communicate using non-VLC signals (e.g., radio frequency signals using Bluetooth). In such a case, the electrical device 140 that is directly communicably isolated in terms of non-VLC signals can indirectly send its data using VLC signals 107 to an adjacent VLC device 141 one or more other electrical devices 140 using VLC signals 107. Alternatively, other types of signals (e.g., radio frequency signals) can be used for communication between electrical devices 140 and/or the network manager 180 in the system 100.

An electrical device 140 can include a housing. The housing can include at least one wall that forms a cavity. In some cases, the housing can be designed to comply with any applicable standards so that the electrical device 140 (and so also the VLC device 141) can be located in a particular environment (e.g., outdoors) for the retail space 109. The housing of an electrical device 140 can be used to house one or more components of the electrical device 140, including one or more components of the VLC device 141. In alternative embodiments, any one or more of these or other components of the electrical device 140 can be disposed on the housing and/or remotely from the housing. For instance, the transceiver 224 (or portion thereof) can be disposed on or integrated with the housing of the electrical device 140.

In embodiments, each electrical device 140 and associated VLC device 141 can be in a predetermined position or fixed position within the retail space 109. The predetermined position or fixed position of each electrical device 140, including an associated VLC device 141, can be known by the network manager 180. The location of the electrical devices 140 and VLC devices 141 in the retail space 109 can be used, along with the data provided by each local device 170 to the network manager 180 at various points in time, by the network manager 180 to identify a location of a local device 170 within the retail space 109 at a point in time and track the movement (e.g., speed, direction, pauses, inactivity) of that local device 170 over a period of time.

The network manager 180, as detailed in FIG. 4, is a device or component that controls all or a portion of the system 100, including the local devices 170, the electrical devices 140, and corresponding VLC devices 141, that are communicably coupled to the network manager 180 via one or more communication links 105. The network manager 180 includes a controller 404 and an optional user interface 427. The controller 404 can include one or more of a number of components. As shown in FIG. 4, such components can include, but are not limited to, a control engine 406, a communication module 408, a timer 410, a power module 412, a storage repository 430, a hardware processor 420, a memory 422, a transceiver 424, an application interface 426, and, optionally, a security module 428. The network manager 180 (or components thereof) can be located in or near the retail space 109. In addition, or in the alternative, the network manager 180 (or components thereof) can be located remotely from (e.g., the cloud) the retail space 109.

The storage repository 430 can be a persistent storage device (or set of devices) that stores software and data used to assist the controller 404 in communicating with the users 150 (including associated user systems 155) and the electrical devices 140 (including associated VLC devices 141) within the system 100. In one or more example embodiments, the storage repository 430 stores one or more protocols 432, algorithms 433, and stored data 434. The protocols 432 of the storage repository 430 can be any procedures (e.g., a series of method steps) and/or other similar operational procedures that the control engine 406 of the controller 404 follows based on certain conditions at a point in time.

The protocols 432 can include any of a number of communication protocols that are used to send and/or receive data between the controller 404 of the network manager 180, the users 150 (including associated user systems 155), the local devices 170, and the electrical devices 140 (including associated VLC devices 141). Such protocols 432 used for communication can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 432 can provide a layer of security to the data transferred within the system 100. Other protocols 432 used for communication can be associated with the use of Wi-Fi, Zigbee, VLC, cellular networking, Bluetooth Low Energy (BLE), ultrawide band (UWB), and Bluetooth.

The algorithms 433 can be any formulas, mathematical models, forecasts, simulations, and/or other similar tools that the control engine 406 of the controller 404 uses to reach a computational conclusion. For example, one or more algorithms 433 can be used to determine how many consumers 175 are associated with a particular local device 170 over a period of time (e.g., a day). As another example, one or more algorithms 433 can be used to determine the speed at which a consumer 175 moves in the retail space 109 based on data received from a local device 170.

Stored data 434 can be any data associated with the electrical devices 140 (including any associated VLC devices 141), the local devices 170, the consumers 175, the retail space 109, the users 150 (including any associated user devices 155), data received from the electrical devices 140 (processed from VLC signals 107 received by any associated VLC devices 141), threshold values, tables, results of previously run or calculated algorithms 433, updates to protocols 432, user preferences, and/or any other suitable data. Such data can be any type of data, including but not limited to historical data, present data, and future data (e.g., forecasts). The stored data 434 can be associated with some measurement of time derived, for example, from the timer 410.

Examples of a storage repository 430 can include, but are not limited to, a database (or a number of databases), a file system, cloud-based storage, a hard drive, flash memory, some other form of solid state data storage, or any suitable combination thereof. The storage repository 430 can be located on multiple physical machines, each storing all or a portion of the communication protocols 432, the algorithms 433, and/or the stored data 434 according to some example embodiments. Each storage unit or device can be physically located in the same or in a different geographic location.

The storage repository 430 can be operatively connected to the control engine 406. In one or more example embodiments, the control engine 406 includes functionality to communicate with the users 150 (including associated user systems 155), the local devices 170, and the electrical devices 140 (including associated VLC devices 141) in the system 100. More specifically, the control engine 406 sends information to and/or receives information from the storage repository 430 in order to communicate with the users 150 (including associated user systems 155), the local devices 170, and the electrical devices 140 (including associated VLC devices 141). As discussed below, the storage repository 430 can also be operatively connected to the communication module 408 in certain example embodiments.

In certain example embodiments, the control engine 406 of the controller 404 controls the operation of one or more components (e.g., the communication module 408, the timer 410, the transceiver 424) of the controller 404. For example, the control engine 406 can activate the communication module 408 when the communication module 408 is in “sleep” mode and when the communication module 408 is needed to send data received from another component (e.g., a local device 170) in the system 100.

The control engine 406 of the controller 404 can communicate with one or more of the local devices 170 to receive data (e.g., an ID of a VLC device 141 and/or an electrical device 140, an image taken by the image capturing device 374 of a local device 170 within the retail space 109, metadata associated with an image taken by the image capturing device 374 of a local device 170 within the retail space 109) that can be used to analyze behavior of one or more consumers 175 in the retail space 109 over a period of time (e.g., a day). For example, the control engine 406 can use one or more protocols 432 to facilitate communication with the local devices 170.

As another example, the control engine 406 can have (as stored data 434 in the storage repository 430) a three-dimensional layout of the entire retail space 109, including the precise locations of each VLC device 141 and each electrical device 140. The control engine 406 can use this information, as well as one or more protocols 432 and/or algorithms 433 to analyze each of the images (or metadata associated with each image) and identification information received from the local devices 170, to locate the local device 170 within the retail space 109 at a particular point in time. As yet another example, the control engine 406 can use one or more algorithms 433 and/or protocols 432 to further process all of the data received from the local devices 170 to generate clusters based on time and distance, and then use these results to generate conclusions of behavior of each consumer 175 (or groups of consumers 175) within the retail space 109. As still another example, the control engine 406 can generate, based on the results of analyzing the data received from the local devices 170, recommendations to a user 150 as to how to modify and improve the retail space 109.

The control engine 406 can generate and process data associated with control, communication, and/or other signals sent to and received from the users 150 (including associated user systems 155), the local devices 170, and the electrical devices 140 (including associated VLC devices 141). The control engine 406 can control one or more of the VLC devices 141 and/or one or more of the local devices 170. In certain embodiments, the control engine 406 of the controller 404 can communicate with one or more components of a system external to the system 100. For example, the control engine 406 can interact with an inventory management system by ordering shelving, flooring, luminaires, and/or other elements for updating the retail space 109 based on analyzing behavior of the consumers 175. In this way, the controller 404 is capable of performing a number of functions beyond what could reasonably be considered a routine task.

In certain example embodiments, the control engine 406 can include an interface that enables the control engine 406 to communicate with the local devices 170, the electrical devices 140, and the users 150. For example, if an electrical device 140 operates under IEC Standard 62386, then the electrical device 140 can have a serial communication interface that will transfer data (e.g., data associated with a local device 170) received by the local device 170. In such a case, the control engine 406 can also include a serial interface to enable communication with the local device 170. Such an interface can operate in conjunction with, or independently of, the communication protocols 432 used to communicate between the controller 404 and the users 150 (including corresponding user systems 155), the local devices 170, and the electrical devices 140 (including corresponding VLC devices 141).

The control engine 406 (or other components of the controller 404) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 408 of the controller 404 determines and implements the communication protocol (e.g., from the protocols 432 of the storage repository 430) that is used when the control engine 406 communicates with (e.g., sends signals to, receives signals from) the user systems 155, the local devices 170, and the electrical devices 140. In some cases, the communication module 408 accesses the stored data 434 to determine which communication protocol is used to communicate with a local device 170. In addition, the communication module 408 can identify and/or interpret the communication protocol of a communication received by the controller 404 so that the control engine 406 can interpret the communication. The communication module 408 can also provide one or more of a number of other services with respect to data sent from and received by the controller 404. Such services can include, but are not limited to, data packet routing information and procedures to follow in the event of data interruption.

The timer 410 of the controller 404 can track clock time, intervals of time, an amount of time, and/or any other measure of time. The timer 410 can also count the number of occurrences of an event, whether with or without respect to time. Alternatively, the control engine 406 can perform the counting function. The timer 410 is able to track multiple time measurements concurrently. The timer 410 can track time periods based on an instruction received from the control engine 406, based on an instruction received from a user 150, based on an instruction programmed in the software for the controller 404, based on some other condition or from some other component, or from any combination thereof. In certain example embodiments, the timer 410 can provide a time stamp for each packet of data received from an electrical device 140.

The power module 412 of the controller 404 receives power from a power supply (e.g., AC mains) and manipulates (e.g., transforms, rectifies, inverts) that power to provide the manipulated power to one or more other components (e.g., the timer 410, the control engine 406) of the controller 404, where the manipulated power is of a type (e.g., alternating current, direct current) and level (e.g., 12V, 24V, 120V) that can be used by the other components of the controller 404. The power module 412 can include one or more of a number of single or multiple discrete components (e.g., transistor, diode, resistor, transformer), and/or a microprocessor. The power module 412 may include a printed circuit board, upon which the microprocessor and/or one or more discrete components are positioned. In some cases, the power module 412 can include one or more components that allow the power module 412 to measure one or more elements of power (e.g., voltage, current) that is delivered to and/or sent from the power module 412. In addition, or in the alternative, the power module 412 can be a source of power in itself to provide signals to the other components of the controller 404. For example, the power module 412 can be or include an energy storage device (e.g., a battery). As another example, the power module 412 can be or include a localized photovoltaic power system.

The hardware processor 420 of the controller 404 executes software, algorithms, and firmware in accordance with one or more example embodiments. Specifically, the hardware processor 420 can execute software on the control engine 406 or any other portion of the controller 404, as well as software used by the users 150 (including associated user systems 155) and/or the electrical devices 140 (including associated VLC devices 141). The hardware processor 420 can be an integrated circuit, a central processing unit, a multi-core processing chip, SoC, a multi-chip module including multiple multi-core processing chips, or other hardware processor in one or more example embodiments. The hardware processor 420 can be known by other names, including but not limited to a computer processor, a microprocessor, and a multi-core processor.

In one or more example embodiments, the hardware processor 420 executes software instructions stored in memory 422. The memory 422 includes one or more cache memories, main memory, and/or any other suitable type of memory. The memory 422 can include volatile and/or non-volatile memory. The memory 422 is discretely located within the controller 404 relative to the hardware processor 420 according to some example embodiments. In certain configurations, the memory 422 can be integrated with the hardware processor 420.

In certain example embodiments, the controller 404 does not include a hardware processor 420. In such a case, the controller 404 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 404 (or portions thereof) to be programmable and function according to certain logic rules and thresholds without the use of a hardware processor. Alternatively, FPGAs, IGBTs, ICs, and/or similar devices can be used in conjunction with one or more hardware processors 420.

The transceiver 424 of the controller 404 can send and/or receive control and/or communication signals. Specifically, the transceiver 424 can be used to transfer data between the controller 404 and the users 150 (including associated user systems 155), the local devices 170, and the electrical devices 140 (including associated VLC devices 141). The transceiver 424 can use wired and/or wireless technology. The transceiver 424 can be configured in such a way that the control and/or communication signals sent and/or received by the transceiver 424 can be received and/or sent by another transceiver that is part of a user system 155, a local device 170, and/or an electrical device 140 (including an associated VLC device 141). The transceiver 424 can send and/or receive any of a number of signal types, including but not limited to radio signals and VLC signals 107.

When the transceiver 424 uses wireless technology, any type of wireless technology can be used by the transceiver 424 in sending and receiving signals. Such wireless technology can include, but is not limited to, Wi-Fi, Zigbee, VLC, cellular networking, BLE, UWB, and Bluetooth. The transceiver 424 can use one or more of any number of suitable communication protocols (e.g., ISA100, HART) when sending and/or receiving signals.

Optionally, in one or more example embodiments, the security module 428 secures interactions between the controller 404, the users 150 (including associated user systems 155), the local devices 170, and the electrical devices 140 (including associated VLC devices 141). More specifically, the security module 428 authenticates communication from software based on security keys verifying the identity of the source of the communication. For example, user software may be associated with a security key enabling the software of a user system 155 to interact with the controller 404. Further, the security module 428 can restrict receipt of information, requests for information, and/or access to information.

A user 150 can be any person that interacts with the network manager 180. Examples of a user 150 may include, but are not limited to, a business owner, an engineer, a company representative, a marketing professional, an architect, an actuary professional, a consultant, a retail space designer, an inventory management system, an inventory manager, a labor scheduling system, a contractor, and a manufacturer's representative. A user 150 can use one or more user systems 155, which may include a display (e.g., a GUI). A user 150 (including an associated user system 155) can interact with (e.g., sends data to, receives data from) the controller 404 of the network manager 180 via the application interface 426 and using the communication links 105. The user 150 can also interact with the network manager 180 using the user interface 427 of the network manager 180 when the user interface 427 exists.

Interaction between a user 150 (including an associated user system 155), the electrical devices 140, the local devices 170, and the network manager 180 can be conducted using communication links 105. Each communication link 105 can include wired (e.g., Class 1 electrical cables, Class 2 electrical cables, electrical connectors, power line carrier, DALI, RS485) and/or wireless (e.g., Wi-Fi, visible light communication, cellular networking, Bluetooth, UWB, WirelessHART, ISA100) technology. A communication link 105 can transmit signals (e.g., power signals, communication signals, control signals, data) between the users 150 (including associated user systems 155), the electrical devices 140, the local devices 170, and the network manager 180.

A user 150 (including an associated user system 155), the local devices 170, and the electrical devices 140 can interact with the controller 404 of the network manager 180 using the application interface 426 in accordance with one or more example embodiments. Specifically, the application interface 426 of the controller 404 receives data (e.g., information, communications, instructions, updates to firmware) from and sends data (e.g., information, communications, instructions) to the user systems 155 of the users 150, the local devices 170, and/or the electrical devices 140. Examples of an application interface 426 can be or include, but are not limited to, an application programming interface, a keyboard, a web service, a data protocol adapter, some other hardware and/or software, or any suitable combination thereof. Similarly, the user systems 155 of the users 150, the local devices 170, and/or the electrical devices 140 can include an interface (similar to the application interface 426 of the controller 404 of the network manager 180) to receive data from and send data to the controller 404 in certain example embodiments.

In addition, a user system 155 of a user 150, one or more of the local devices 170, and one or more of the electrical devices 140 can include a user interface (similar to the user interface 427 of the network manager 180). Examples of such a user interface can include, but are not limited to, a graphical user interface, a touchscreen, a keyboard, a monitor, a mouse, some other hardware, or any suitable combination thereof. The controller 404, the users 150 (including associated user systems 155), the local devices 170, and the network manager 180 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 404. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 5.

Further, as discussed above, such a system can have corresponding software (e.g., user software, sensor software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

FIG. 5 illustrates one embodiment of a computing device 518 that implements one or more of the various techniques described herein, and which is representative, in whole or in part, of the elements described herein pursuant to certain example embodiments. For example, the controller 404 of the network manager 180 (including components thereof, such as the control engine 406, the hardware processor 420, the storage repository 430, the power supply 440, and the transceiver 424) can be considered a computing device 518. Computing device 518 is one example of a computing device and is not intended to suggest any limitation as to scope of use or functionality of the computing device and/or its possible architectures. Neither should the computing device 518 be interpreted as having any dependency or requirement relating to any one or combination of components illustrated in the example computing device 518.

The computing device 518 includes one or more processors or processing units 514, one or more memory/storage components 515, one or more input/output (I/O) devices 516, and a bus 517 that allows the various components and devices to communicate with one another. The bus 517 represents one or more of any of several types of bus structures, including a memory bus or memory controller, a peripheral bus, an accelerated graphics port, and a processor or local bus using any of a variety of bus architectures. The bus 517 includes wired and/or wireless buses.

The memory/storage component 515 represents one or more computer storage media. The memory/storage component 515 includes volatile media (such as random access memory (RAM)) and/or nonvolatile media (such as read only memory (ROM), flash memory, optical disks, magnetic disks, and so forth). The memory/storage component 515 includes fixed media (e.g., RAM, ROM, a fixed hard drive, etc.) as well as removable media (e.g., a Flash memory drive, a removable hard drive, an optical disk, and so forth).

One or more I/O devices 516 allow a user 150 to enter commands and information to the computing device 518, and also allow information to be presented to the user 150 and/or other components or devices. Examples of input devices 516 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 518 is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 518 includes at least the minimal processing, input, and/or output means necessary to practice one or more embodiments.

Further, those skilled in the art will appreciate that one or more elements of the aforementioned computer device 518 is located at a remote location and connected to the other elements over a network in certain example embodiments. Further, one or more embodiments is implemented on a distributed system having one or more nodes, where each portion of the implementation (e.g., a VLC device 141 of an electrical device 140, a local device 170, the network manager 180) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

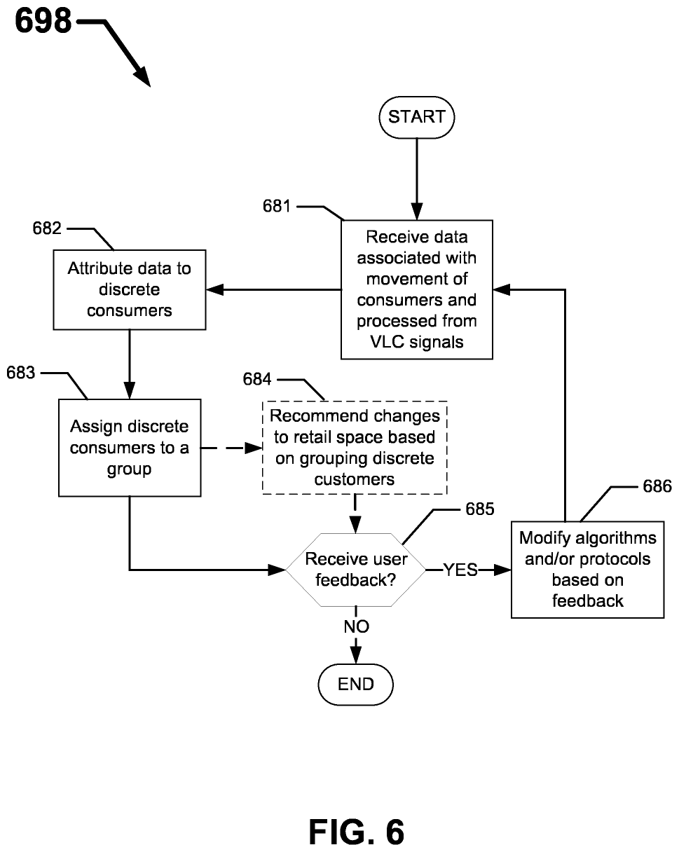

FIG. 6 shows a flowchart 698 of a method for analyzing consumer behavior within a retail space according to certain example embodiments. While the various steps in this flowchart 698 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order.

In addition, a person of ordinary skill in the art will appreciate that additional steps not shown in FIG. 6 may be included in performing this method. Accordingly, the specific arrangement of steps should not be construed as limiting the scope. Further, a particular computing device, such as the computing device discussed above with respect to FIG. 5, can be used to perform one or more of the steps for the methods shown in FIG. 6 in certain example embodiments. Any of the functions performed below by the controller 404 can involve the use of one or more protocols 432, one or more algorithms 433, and/or stored data 434.

The method shown in FIG. 6 is merely an example that can be performed by using an example system described herein. In other words, systems for analyzing consumer behavior within a retail space 109 can perform other functions using other methods in addition to and/or aside from those shown in FIG. 6. Referring to FIGS. 1 through 6, the method shown in the flowchart 698 of FIG. 6 begins at the START step and proceeds to step 681, where data associated with movement of consumers 175 and processed from VLC signals 107 is received. The data can be received by the controller 404 of the network manager 180 using one or more protocols 433 and/or algorithms 432. The data is received from one or more local devices 170 located in the retail space 109.

The data received by the controller 404 from each local device 170 can include an identification of one or more VLC devices 141 and/or electrical devices 140, which are received by the local device 170 in a VLC signal 107 broadcast by the one or more VLC devices 141. The data received by the controller 404 from each local device 170 can include an image, taken by an image capturing device 374 of the local device 170, where the image includes the VLC device 141 that sent the VLC signal 107 and/or the electrical device 140 associated with the VLC device 141. The data received by the controller 404 from each local device 170 can additionally or alternatively include time series location data for each local device 170. In certain example embodiments, the data received by the controller 404 from each local device 170 does not include an identification of the local device 170 or the associated consumer 175. The controller 404 can receive the data from the local devices 170 using any of a number of different types of signals, including but not limited to VLC signals (e.g., VLC signals 107) and radio frequency signals.

The VLC devices 141 of the electrical devices 140 broadcast the VLC signals 107 received by the local devices 170 in the retail space 109. Each local device 170 can have its own local controller (e.g., local controller 304) to extract the data (an identification of the VLC device 141 and/or the associated electrical device 140) included in the VLC signals 107 received from the VLC device 141 and put the data in a format that can be received and interpreted by the controller 404 of the network manager 180. Each local device 170 located in the retail space 109 is associated with a consumer 175 within the retail space 109. In certain example embodiments, the local device 170 merely provides identification information for a VLC device 141 and/or an associated electrical device 140 and an image of the VLC device 141 and/or associated electrical device 140 in real time within the retail space 109 without identifying the associated consumer 175 or any characteristics (e.g., gender, age, height, weight, ethnicity, accompanied by others, handicap) about the consumer 175.

The data can be received by the controller 404 of the network manager 180 from the local devices 170 at any interval (e.g., instantaneously, continuously, periodically, randomly). The data is received by the controller 404 of the network manager 180 over a period of time (e.g., a day during business hours, an hour, a time of day (e.g., morning, afternoon, evening), a block of time (e.g., over lunch hour (e.g., noon to 1:00 pm), within the first 2 hours after opening, within the last 90 minutes before closing). The data received by the controller 404 of the network manager 180 can include a time stamp. Alternatively, the controller 404 of the network manager 180 can associate a time with the data based on the time that the data is received from a local device 170. The data received by the controller 404 of the network manager 180 can be stored in the storage repository 430 as stored data 434 (e.g., in tables).

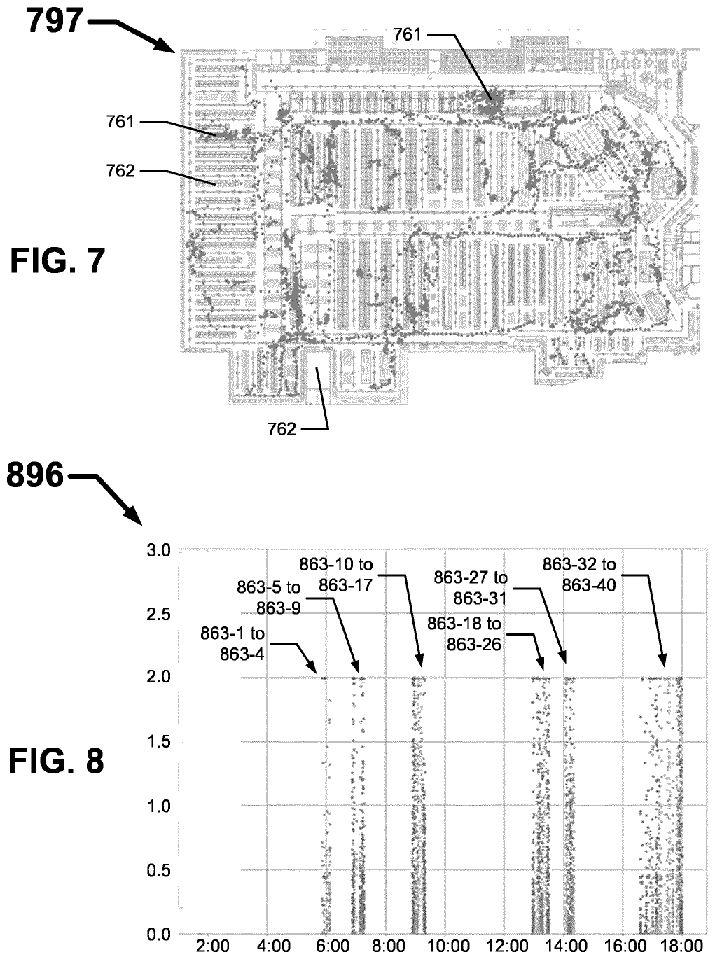

FIG. 7 shows a plot 797 of locational data points 761 for a local device 170 within a retail space 109 according to certain example embodiments. Referring to FIGS. 1 through 7, the plot 797 is for a business day (e.g., 13 continuous hours in total). Assuming that no single consumer 175 is shopping in the retail space 109 for the entire business day, the plot 797 of data points 761 is for multiple consumers 175 throughout the day. The retail space 109 shows all of the retail infrastructure 762 (e.g., shelves, shelf locations, product placement, retail signage (e.g., the wording and/or location of signs that inform consumers 175 where certain retail products or categories of retail products are located in the retail space 109), walls, displays, checkout counters, consumer service desks, restrooms, temporary sampling stations) located on or near the floor level of the retail space 109 at a point in time and serve as obstacles around which each consumer 175 must navigate and/or destinations to which each consumer 175 may approach when traveling through the retail space 109. Since each locational data point 761 is associated with a time stamp, the controller 404 of the network manager 180 can sort the locational data points 761 in chronological order.

In step 682, the data received in step 681 is attributed to discrete consumers 175. The data is attributed to discrete consumers 175 by the controller 404 of the network manager 180 using one or more protocols 433 and/or algorithms 432. The controller 404 can attribute the data to discrete consumers 175 continuously, periodically (e.g., after every business day), randomly, on the occurrence of some event (e.g., the local device 170 is returned to a charging station), or on some other basis. A discrete consumer 175 is what the controller 404 estimates to be an actual consumer associated with the data.

In certain example embodiments, the controller 404 uses a multi-stage process to attribute the data to discrete consumers 175. For example, the controller 404 of the network manager 180 can initially determine the movement of a local device 170 over a period of time (e.g., a business day) and establish a speed profile to the data based on the movement of the local device 170. For example, the controller 404 can use one or more algorithms 433 to cluster the movement speed profile of the local device 170 across the time domain using the k-means algorithm to obtain multiple small clusters, as shown in FIG. 8. In such a case, the numerous (e.g., hundreds, thousands) data points with location fixes during the day in the retail space 109 can be put in an observation vector [(x₁, x₂, . . . , xₙ)] by the controller 404, where each observation is a d-dimensional real vector.

The controller 404 can subsequently partition the n observations into k clusters by utilizing k-means clustering, where the partitioning of the n observations into k (≤n) sets S=(S₁, S₂, . . . , Sₖ) can be chosen by the controller 404 to minimize the within-cluster sum of squares (WCSS). For instance, the controller 404 can have d=1 and k=40. The number n can be several thousand and can vary significantly depending on the utilization of the local device 170 for the day (or other period of time). Other movement profiles (aside from speed profiles) can also be categorized using example embodiments. Other such movement profiles can include, but are not limited to, consistency of speed, consistency of direction, rates of accelerations/decelerations, frequency of accelerations/decelerations. For example, a consumer 175 talking on a local device 170 that is also a smart phone is likely to have a stop-and-go movement patter during the conversation. As another example, a consumer 175 texting on a local device 170 that is also a smart phone is likely to walk more slowly while reading a text message and stop completely while generating a text message.

Also, in certain example embodiments, other types of vector quantization methods aside from k-means clustering can be used by the controller 404 to cluster the data. Examples of other types of vector quantization methods can include, but are not limited to, DBSCAN, EM clustering using Gaussian mixture models (GMM), K-SVD, principal component analysis, mean shift clustering, independent component analysis, and bilateral filtering.

FIG. 8 shows a graph 896 of clusters 863 (sometimes called initial clusters 863 herein) of the locational data points 761 for a local device 170 within the retail space 109 according to certain example embodiments. The clusters 863 of data points 761 are plotted by speed (in this case, in meters per second) along the vertical axis and time (in this case, in hours) along the horizontal axis. In this case, the graph 896 shows 40 clusters 863, represented as cluster 863-1 through cluster 863-40. Each cluster 863 (e.g., cluster 863-1, cluster 863-40) is configured to be a collection of data points from a single local device 170 that have a common characteristic (in this case, movement speed) over a relatively consecutive time period or relatively consecutive broadcasts of VLC signals 107 by the local device 170.

The controller 404 of the network manager 180 determines that clusters 863-1 through 863-4 represent the movements of one consumer 175 (e.g., consumer 175-1) in the retail space 109 between around 5:45 and 6:15 in the morning. The controller 404 of the network manager 180 determines that clusters 863-5 through 863-9 represent the movements of another consumer 175 in the retail space 109 between around 6:45 and 7:20 in the morning. The controller 404 of the network manager 180 determines that clusters 863-10 through 863-17 represent the movements of yet another consumer 175 in the retail space 109 between around 8:50 and 9:25 in the morning. The controller 404 of the network manager 180 determines that clusters 863-18 through 863-26 represent the movements of still another consumer 175 in the retail space 109 between around 12:50 and 1:30 in the afternoon. The controller 404 of the network manager 180 determines that clusters 863-27 through 863-31 represent the movements of yet another consumer 175 in the retail space 109 between around 2:00 and 2:25 in the afternoon. The controller 404 of the network manager 180 determines that clusters 863-32 through 863-40 represent the movements of still another consumer 175 in the retail space 109 between around 4:30 and 6:00 in the afternoon.

However, in some cases, these initial clusters 863 do not accurately correspond to a single consumer 175. In such cases, additional clustering may be performed by the controller 404 of the network manager 180. For instance, the initial clusters 863 may merge multiple consumers 175. For example, if the retail space 109 is very busy with consumers 175, the local device 170 can be passed from one consumer 175 to another consumer 175 without an appreciable gap in time. As another example, if the local device 170 is attached to a shopping cart, and most of the shopping carts at the retail space 109 are in the parking lot and not brought back into the retail space 109 for use, then the shopping cart to which the local device 170 is attached can get an inordinate amount of use by multiple consumers 175 over a period of time (e.g., an hour), even if the retail space 109 does not have an inordinately large number of consumers 175 during that period of time.

In other cases, the opposite problem may occur when the controller 404 uses different protocols 432 and/or algorithms 433 in the first stage of the process of attributing the locational data points 761 to discrete consumers 175. Specifically, the initial clusters 863 identified in the first stage of the process of attributing data to discrete consumers 175, based on the location data points 761, can lead to too few actual consumers 175 being counted in the behavioral analysis. For example, while the graph 896 of FIG. 8 shows that 6 consumers 175 used the local device 170 on that day, the actual number of consumers 175 that actually used the local device 170 on that day was 8. To address this issue in either case, one or more additional stages for attributing data to discrete consumers 175 (additional clustering) can be performed by the controller 404 of the network manager 180 based on the initial clusters 863 that resulted in the first stage of the process.

For example, the controller 404 can use one or more other protocols 432 and/or algorithms 433 to further merge two or more of the initial clusters 863 based on, for instance, the distance traveled within each initial cluster 863, the time gap between the initial clusters 863 (e.g., the gap in time between cluster 863-2 and cluster 863-3), and the relative locations within the retail space 109 between adjacent clusters 863. In such a case, the controller 404 can merge multiple initial clusters 863 based on certain rules (e.g., types of protocols 432). As an example, the controller 404 can determine that the time interval between two initial clusters 863 is less than the threshold Tₜₕ, which means the same consumer 175 might stop for a moment for some reason (e.g., to get something on a shelf in the retail space, to examine a product on a shelf in the retail space 109, to perform an action (e.g., type and send a text message, make a phone call) on her/his phone.

As another example, the controller 404 can determine that the distance between the end position of the local device 170 in one cluster 863 and the starting position of the local device 170 in the following cluster 863 is less than the threshold Dₜₕ, which means the local device 170 may have lost the ability to send a VLC signal 107 or no VLC devices 141 were able to receive the VLC signals 107 broadcast by the local device 170 for a moment (i.e., no change of user). As still another example, the controller 404 can determine that the distance of the end position of one cluster 863 to the location in the retail space 109 where the local device 170 is kept after use falls below a threshold value, which means that the local device 170 may already be in a charging station. When placed in the charging station, the local device 170 may not transmit any VLC signals 107, or otherwise such VLC signals 107 are discarded by the controller 404 of the network manager 180. Threshold values and ranges of acceptable values (which can be bound by threshold values) can be established, maintained, and modified as needed by the controller 404, such as when attributing data to discrete consumers 175. Such values can be unique to each retail space 109.

In some cases, such as with retailers have protocols in place for employees to disinfect a cart or other vehicle to which a local device 170 can be attached or integrated, certain motions of the local device 170 during these times can be captured in VLC signals 107 broadcast by the local device 170 to indicate to the controller 404 that the local device 170, at that point in time, is between consumers 175. This information can further help the controller 404 to accurately attribute certain clusters 863 of data to a discrete consumer 175.

In step 683, the discrete consumers 175 established in step 682 are assigned to groups. In certain example embodiments, the discrete consumers 175 are assigned to groups by the controller 404 using one or more protocols 432 and/or algorithms 433. The groups can be established, maintained, and/or modified by the controller 404 of the network manager 180 and/or by one or more users 150. Consumers 175 assigned to a group can have one or more similar shopping characteristics (e.g., time spent in the retail space 109, speed of travel in the retail space 109, total distance traveled in the retail space 109, areas of the retail space 109 avoided and/or visited, time of day spent in the retail space 109) relative to each other.

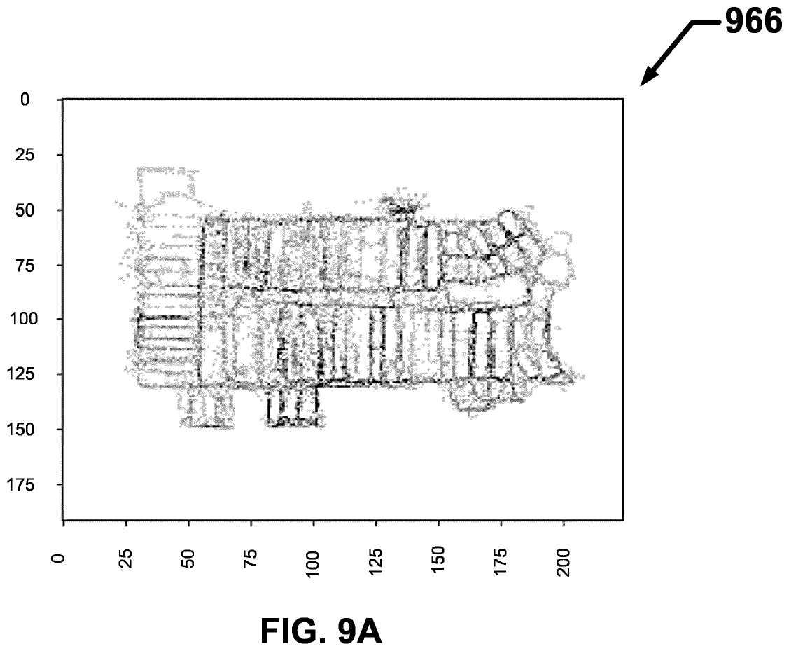

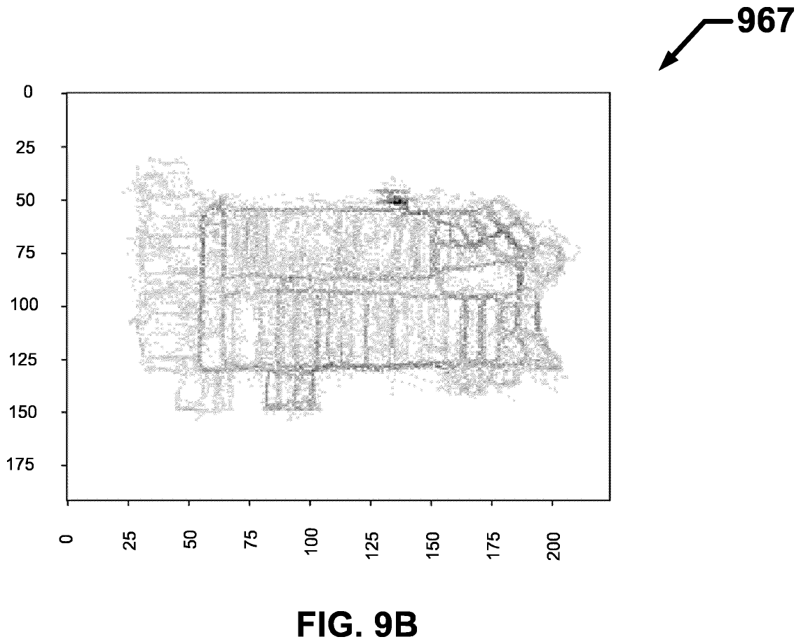

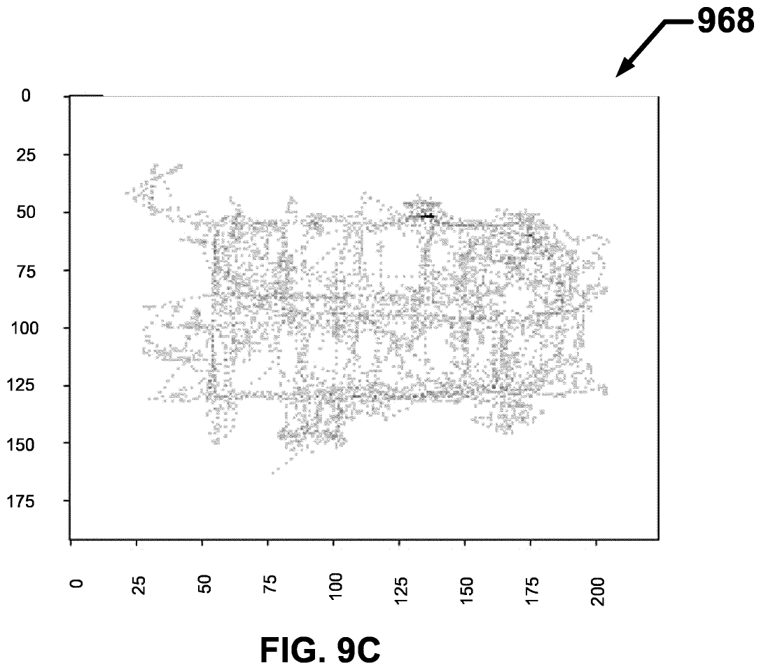

Since the travel path of each consumer 175 in the retail space 109 is restricted to remain within the physical bounds of the store, the controller 404 of the network manager 180 can use matrices to represent the travel paths of the consumers 175. For example, as shown in FIGS. 9A through 9C, the retail space 109 is represented by a matrix with size of 192×224. The matrix elements on a travel path (as determined by the VLC signals 107) are set to 1, while the remaining matrix elements are set to 0. If the consumer 175 shows up n times at a certain location in the retail space 109, the corresponding elements in the matrix could be set to n, which results in that point or cell in the matrix having a darker shade in FIGS. 9A through 9C. By using this matrix method, the retail space 109 is reduced to a 2-dimensional area.

The controller 404 of the network manager 180 can also apply other theoretical principals, such as the Principal Component Analysis (PCA) method, to reduce the dimensions within the retail space 109, and then select the most L (L=8, 16, 32, . . . ) significant eigenvalues from those results. After completing the PCA method, the k-means algorithm can be applied by the controller 404 to cluster these matrices. For example, based on analyzing the data associated with the consumers 175, the controller 404 can choose L=16 and then choose K=10 for travel-path clustering.

FIGS. 9A through 9C show aggregated paths of three groups of consumers 175. The first group 966, shown in FIG. 9A, consists of 17 discrete consumers 175 with an average travel distance of 1886 meters within the retail space 109 and a dwell time of 85 minutes in the retail space 109. These averages for total distance and dwell time are the highest among all of the discrete consumers 175 for the period of time in the retail space 109, but the average speed of travel of 0.59 meters per second in the retail space 109 for the consumers 175 in this group is relatively low when compared with the other consumers 175.

The second group 967, shown in FIG. 9B, consists of 61 discrete consumers 175 with an average travel distance of 753 meters and an average dwell time of 34 minutes. These average distance and dwell time are substantially the same as the average distance and dwell time for all the consumers (e.g., over 400) for that day. The average speed of travel for the consumers 175 in group 967 is 0.66 meters per second. The third group 968, shown in FIG. 9C, consists of 32 discrete consumers 175 with an average travel distance of 427 meters and an average dwell time of 18 minutes, both of which are much shorter than those averages for the group 966 and the group 967. However, the average speed of travel of the consumers 175 in the group 968 is 0.79 meters per second, which is higher than the average speed of travel for the consumers 175 in the group 966 and in the group 967. At other times, the controller 404 can generate other groups in addition to or in place of one or more of the groups 966, 967, and 968 in this example.

Upon further analysis of the data associated with the consumers 175, the controller 404 can use additional protocols 432 and/or algorithms 433 to further inspect the path of travel of each individual consumer 175 within these three groups (group 966, group 967, and group 968). In such a case, the controller 404 can determine that the consumers 175 in the group 966, as shown in FIG. 9A, usually stop at many places and walk many small loops in the retail space 109. Similarly, the controller 404 can determine that the consumers 175 in the group 967, as shown in FIG. 9B, usually walk a big loop in the retail space 109 and walk much less in a small loop pattern. Further, the controller 404 can determine that the consumers 175 in the group 968, as shown in FIG. 9C, usually go to some destinations in the retail space 109 directly and then leave the retail space 109 relatively quickly.

Consistency of directionality of a motion trail is also a characteristic that can be used to group consumers 175. For example, if a consumer 175 knows exactly what the consumer 175 wants to buy and knows where to locate those items in the retail space 109, the motion trail of that consumer 175 will be very direct and at a relatively quicker pace with little sideways fluctuations or slow rates of speed. By contrast, a consumer 175 who is browsing without specific purchases in mind will tend to have a motion trail that meanders and has a relatively slower pace.

A consumer 175 can be assigned to more than one group. For example, if the consumer 175 is elderly, the consumer 175 can be grouped with other consumers 175 as having a slow pace, but that consumer 175 can also be grouped with other consumers 175 as being goal-oriented (e.g., having a straight motion trail to buy certain products within the retail space 109).

Once step 683 is complete, the process can proceed to step 685. Alternatively, in certain optional example embodiments, the process can proceed from step 683 to step 684. In optional step 684, which exists if the controller 404 of the network manager 180 is configured to further analyze the data received indirectly from the local devices 170 in the retail space, changes to the retail space 109 can be recommended based on grouping the discrete consumers. Examples of changes to the retail space 109 can include, but are not limited to, a recommendation to rearrange a lighting infrastructure (e.g., location, type, manufacturer of certain electrical devices 140 in the form of luminaires) in the volume of space 109, a recommendation to change lighting settings in the retail space 109, a recommendation as to the placement of product promotion, a recommendation as to optimizing storage and the placement of inventory items, and a recommendation to rearrange some or all of the retail infrastructure (retail infrastructure 762) in the volume of space 109. Any changes to the retail space 109 can be recommended by the controller 404, using one or more algorithms 433 and/or protocols 432, to one or more users 150 (including any associated user systems 155). The controller 404 can make such recommendations at any point in time.

The controller 404 can additionally or alternatively make recommendations for a consumer 175 or group of consumers 175 within the retail space 109. For example, the controller 404 can recommend an indoor navigation route for a customer 175 (e.g., for consumers 175 that are clustered and grouped as being elderly, a recommended navigation route through the retail space 109 can be through areas with calmer shoppers and/or less traffic, even if the recommended navigation path is physically longer than the most direct route). Additionally, or alternatively, the controller 404 can make recommendations about maintenance within the retail space 109. For example, the controller 404 can make a recommendation to adjust a cleaning schedule (e.g., an area of the retail space 109 that is frequented by consumers 175 that are clustered and grouped as being elderly using example embodiments can be cleaned/disinfected more often and/or more thoroughly than other parts of the retail space 109 to better protect those consumers 175 from COVID-19).

For example, the controller 404 can merge groups of consumers 175 and detect the frequent visit of certain groups with certain areas of the retail space 109 to improve the effectiveness of promotion and advertising in the retail space 109. In such a case, the controller 404 can also test studies provided by a user 150 against the shopping behaviour of groups of consumers 175 to determine potential business opportunities.

As another example, the controller 404 can predict employee allocation within the retail space 109 to a user 150 for different points throughout a business day. For instance, the controller 404 can estimate the remaining shopping time for consumers 175 within certain groups, which can help predict the number of consumers 175 that are estimated to check out at different points in time so staff could be scheduled beforehand.

As yet another example, the controller 404 can optimize the layout of the retail space 109 by identifying the travel paths of the various groups of consumers 175. For instance, if a certain group of consumers 175 travels almost everywhere in the store, their paths might not be as important as those groups of consumers 175 who want to hyper-efficiently travel directly only to the products they want to buy. Strategically placing these wanted products in different parts of the retail space 109 can lead to those consumers 175 purchasing other nearby products.

As still another example, the controller 404 can detect different group categories based on their different motion track characteristics. The controller 404 can classify the consumers 175 into several groups associated with their movement pattern across the retail space 109 to enable use cases such as controlling the lighting in the retail space 109 and simultaneously analyzing the distribution of certain groups over the retail space 109 based on the time of the day. For example, if area A of the retail space 109 has a large number of consumers 175 who are elderly during the morning or afternoon time, the controller 404 can tune the light intensity (e.g., to high lumen output to account for the higher lux needs of elderly people's eyes) and the spectrum (e.g., to warm white) to adapt to the rhythm of a slower-paced shopping experience. As another example, if area B of the retail space 109 has a large number of consumers 175 who are young at evening time (e.g., after 6:00 pm) with a limited amount of time in which to shop, the controller 404 can increase the light intensity and tune the lighting to the cool spectrum to encourage a fast and productive shopping experience. In this way, the controller 404 can optimize energy saving measures while also improving the shopping experience for the consumers 175 in a particular group at that particular time.

In step 685, a determination is made as to whether feedback from a user 150 has been received. Feedback can be received directly from a user 150 or a user system 150. Feedback can be received by the controller 404 of the network manager 180. The feedback can be any information associated with the analysis and recommendations made by the controller 404. Examples of such feedback can include, but are not limited to, an actual number of consumers 175 in the retail space 109 at a particular time or over a period of time, user preferences, a change in the layout within the retail space 109, how much sales have increased or decreased after a modification to the layout of the retail space 109, results of retail consumer insight studies, ground truth information, and notification that a particular local device 170 has been failing. If feedback from a user 150 has been received, then the process proceeds to step 686. If feedback from a user 150 not has been received, then the process proceeds to the END step.

In step 686, one or more algorithms 433 and/or protocols 432 are modified based on the feedback received in step 685. The algorithms 433 and/or protocols 432 can be modified by the controller 404 of the network manager 180. The particular algorithms 433 and/or protocols 432 that are modified are identified by the controller 404. In some cases, the controller 404 can add and/or delete one or more algorithms 433 and/or protocols 432 based on the feedback received. With the self-learning nature of the controller 404, the amount of ground truth information provided to the controller 404 by a user 150 should be minimal for the controller 404 to provide optimal results for the user 150. When step 686 is complete, the process reverts to step 681.

Example embodiments can be used to analyze data about consumer behavior in a retail space in real time without requiring or using any personal information about the consumer. Example embodiments can be implemented on existing systems (e.g., lighting systems) within a retail space with little to no modification required to the electrical equipment of such existing systems. Example embodiments can be implemented with new installations of electrical equipment as well as easily installing, retrofitting, or replacing electrical equipment. Example embodiments also provide a number of other benefits. Such other benefits can include, but are not limited to, ease of use, optimization of a retail space, and compliance with industry standards and regulations, including those focused on data and consumer privacy.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art.

Therefore, the scope of the example embodiments is not limited herein.

1. A method for analyzing consumer behavior within a retail space, the method comprising:
receiving, by a controller, a plurality of data associated with a plurality of consumers in a plurality of communications signals from a plurality of local devices located in the retail space, wherein the plurality of local devices receives some of the plurality of data in visible light communication (VLC) signals broadcast by a plurality of electrical devices, wherein each local device is associated with a location of one of the plurality of consumers in the retail space at a point in time, and wherein the plurality of data lacks information that identifies the plurality of consumers;
determining, by the controller, a plurality of clusters for the plurality of data, wherein the plurality of clusters represent movements of discrete consumers within the retail space, wherein the discrete consumer is an estimate of an actual consumer associated the plurality of the data;
attributing, by the controller using a multi-stage clustering process, the plurality of data to the discrete consumers among the plurality of consumers over a period of time that includes each point in time; and
assigning the discrete consumers to at least one of a plurality of groups defined by one or more characteristics measured from the plurality of data, wherein the discrete consumers within a group of the plurality of groups share a common characteristic.

2. The method of claim 1, wherein each communication signal received by the controller from a local device at a point in time comprises an identification of an electrical device conveyed in a VLC signal broadcast by the electrical device and an image or metadata associated with the image, taken by the local device at substantially the point in time, that includes the electrical device.

3. The method of claim 1, wherein the common characteristic comprises at least one of a group consisting of a rate of travel in the retail space, a path of travel in the retail space, a duration of time spent in the retail space, consistency of directionality of a motion trail, and a total distance traveled in the retail space.

4. The method of claim 1, further comprising:
determining, based on assigning the discrete consumers to the at least one of the plurality of groups for the period of time, an adjustment to at least one of a group consisting of a lighting infrastructure, lighting settings, cleaning schedules, indoor navigation routes, and retail infrastructure within the retail space.

5. The method of claim 1, wherein attributing the plurality of data to the discrete consumers for the period of time comprises establishing a plurality of clusters, wherein each cluster of the plurality of clusters corresponds to one of the plurality of consumers.

6. The method of claim 5, wherein attributing the plurality of data to the discrete consumers further comprises:
grouping a subset of the plurality of clusters; and
attributing the data for the subset of the plurality of clusters to a discrete consumer.

7. The method of claim 5, wherein establishing the plurality of clusters comprises:
categorizing a movement profile of each local device across a time domain into one of a plurality of initial clusters; and
modifying at least one of the plurality of initial clusters into a cluster based on a distance traveled by each of the local devices in the initial cluster, a time gap between movements by each local device in the initial cluster, and a relative location of each local device within the initial cluster.

8. The method of claim 7, wherein categorizing the movement profile of each local device across the time domain into one of the plurality of superclusters is performed using vector quantization.

9. The method of claim 1, wherein the common characteristic is a path of travel in the retail space, wherein assigning the discrete consumers to one of the plurality of groups comprises grouping paths of travel of the discrete consumers, and wherein each path of travel is represented in a matrix.

10. The method of claim 9, wherein grouping paths of travel of the discrete consumers comprises reducing a size of each matrix using principal component analysis.

11. The method of claim 10, wherein grouping paths of travel of the discrete consumers further comprises clustering an eigenvalue of each matrix.

12. The method of claim 9, wherein each path of travel is defined in part by building and retail infrastructure of the retail space as applied by the controller.

13. A system for analyzing consumer behavior within a retail space, the system comprising:
a plurality of electrical devices configured to that broadcast a plurality of visible light communication (VLC) signals in a retail space over a period of time, wherein each of the plurality of VLC signals comprises an identification of an electrical device sending the VLC signal;
a plurality of local devices configured to receive the plurality of VLC signals broadcast by the plurality of electrical devices, wherein each local device is used a consumer among a plurality of consumers at a point in time within the period of time; and
a network manager communicably coupled to the plurality of local devices, wherein the network manager is configured to receive a plurality of communication signals from the plurality of local devices, wherein each communication signal comprises the identification of the electrical device sending the VLC signal and an image or metadata associated with the image, taken by the local device, of the electrical device, and wherein the network manager is configured to:
determine a plurality of clusters for the plurality of data, wherein the plurality of clusters represent movements of discrete consumers within the retail space, wherein the discrete consumer is an estimate of an actual consumer associated the plurality of the data;
attribute, using a multi-stage clustering process, data in each of the plurality of communication signals to the discrete consumers among the plurality of consumers for the period of time; and
assign the discrete consumers to at least one of a plurality of groups defined by one or more characteristics measured from the data in the plurality of communication signals, wherein the discrete consumers within a group of the plurality of groups share a common characteristic.

14. The system of claim 13, wherein the network manager comprises a controller configured to execute a plurality of algorithms to attribute the data in the plurality of communication signals to the discrete consumers for the period of time and to assign the discrete consumers to the at least one of the plurality of groups.

15. The system of claim 13, wherein the plurality of local devices and the network manager communicate with each other using non-VLC signals.
